(19) United States
(12) Patent Application Publication
(10) Pub. No.: US 2025/0371862 A1
(43) Pub. Date: Dec. 4, 2025

(54) IMAGE PROCESSING METHOD AND APPARATUS, DEVICE, AND MEDIUM

(71) Applicant: Tencent Technology (Shenzhen) Company Limited, Shenzhen (CN)

(72) Inventor: Zhenhong ZHANG, Shenzhen (CN)

(21) Appl. No.: 19/305,654

(22) Filed: Aug. 20, 2025

Related U.S. Application Data
(63) Continuation of application No. PCT/CN2024/099622, filed on Jun. 17, 2024.

(30) Foreign Application Priority Data
Aug. 25, 2023 (CN) 202311080229.6

(51) Int. Cl. G06V 10/82; G06V 10/77; G06V 40/12

(52) U.S. Cl. CPC G06V 10/82; G06V 10/7715; G06V 40/1347; G06V 40/1365

(57) ABSTRACT

This application discloses an image processing method performed by a computer device. The method includes: obtaining a first sample image including multiple regions; invoking an attention mechanism network to perform attention degree recognition on the regions, to obtain a first region and a second region; adding a first predicted label to the first region and a second predicted label to the second region based on the respective attention degrees of the first region and the second region, and a definition indicated by the first predicted label being higher than a definition indicated by the second predicted label; obtaining a first reference label of the first region and a second reference label of the second region; and updating the attention mechanism network based on a difference between the first predicted label and the first reference label and a difference between the second predicted label and the second reference label.

### CROSS-REFERENCE TO RELATED APPLICATIONS

This application is a continuation application of PCT Patent Application No. PCT/CN2024/099622, entitled “IMAGE PROCESSING METHOD AND APPARATUS, DEVICE, AND MEDIUM” filed on Jun. 17, 2024, which claims priority to Chinese Patent Application No. 2023110802296, entitled “IMAGE PROCESSING METHOD AND APPARATUS, DEVICE, AND MEDIUM” filed with the China National Intellectual Property Administration on Aug. 25, 2023, both of which are incorporated herein by reference in their entirety.

### FIELD OF THE TECHNOLOGY

This application relates to the field of artificial intelligence technologies, and in particular, to an image processing method and apparatus, a device, and a medium.

### BACKGROUND OF THE DISCLOSURE

In a scenario of classifying a palm print image, the palm print image is usually first embedded by using a feature extraction network, to extract an embedding feature of the palm print image, and then the palm print image is classified by using the embedding feature.

The palm print image is photographed by using a camera, and the palm print image may include several regions with different definitions. In an existing application, a palm print image may be directly embedded by using a feature extraction network. In this process, the feature extraction network may pay too much attention to an image of an unclear region in the palm print image, and a feature of the image of the unclear region is usually inaccurate. Consequently, an embedding feature extracted from the palm print image is inaccurate, and further, a classification result of the palm print image is also inaccurate.

### SUMMARY

This application provides an image processing method and apparatus, a device, and a medium, to improve accuracy of extracting an embedding feature of a palm print image, thereby improving accuracy of classifying the palm print image.

An aspect of this application provides an image processing method performed by a computer device. The method includes:
obtaining a first sample image, the first sample image comprising a plurality of regions;
invoking an attention mechanism network to perform attention degree recognition on the plurality of regions, to obtain a first region and a second region, wherein an attention degree to the first region is higher than an attention degree to the second region;
adding a first predicted label to the first region and a second predicted label to the second region based on the respective attention degrees of the first region and the second region, and a definition indicated by the first predicted label being higher than a definition indicated by the second predicted label;
obtaining a first reference label of the first region and a second reference label of the second region; and
updating the attention mechanism network based on a difference between the first predicted label and the first reference label and a difference between the second predicted label and the second reference label, the attention mechanism network being configured to extract an embedding feature of a palm print image for identifying an owner of a palm print in the palm print image.

An aspect of this application provides a computer device, including a memory and a processor, the memory having a computer program stored therein, and the computer program, when executed by the processor, causing the computer device to perform the method according to an aspect in this application.

An aspect of this application provides a non-transitory computer-readable storage medium, the computer-readable storage medium having a computer program stored therein, and the computer program, when executed by a processor of a computer device, causing the computer device to perform the method according to an aspect in this application.

The first sample image in this application may include a plurality of regions subjected to division. For the plurality of regions, if definitions of the regions are different, definition types of the regions may be different. In other words, in this application, the first sample image may be divided based on different definitions of images of respective parts of the first sample image. In this way, in this embodiment, an attention mechanism network can be invoked to perform attention degree recognition on the plurality of regions, to obtain a first region and a second region of the plurality of regions. The attention mechanism network comprises an attention parameter, and the attention mechanism network determines, based on the attention parameter, that an attention degree to the first region is higher than an attention degree to the second region. Therefore, in this application, a first predicted label can be added to the first region and a second predicted label can be added to the second region based on the respective attention degrees of the attention mechanism network to the first region and the second region. The first predicted label is used for indicating that the first region belongs to a first predicted definition type, the second predicted label is used for indicating that the second region belongs to a second predicted definition type, and a definition indicated by the first predicted definition type is higher than a definition indicated by the second predicted definition type. In other words, in this application, a region to which the attention mechanism network pays more attention may be marked with a predicted label indicating a higher image definition. In addition, in this application, a first reference label of the first region and a second reference label of the second region can be obtained. The first reference label is used for indicating a first reference definition type that the first region actually belongs to, and the second reference label is used for indicating a second reference definition type that the second region actually belongs to. Therefore, in this application, the attention parameter of the attention mechanism network can be corrected based on a difference between the first predicted label and the first reference label and a difference between the second predicted label and the second reference label. Subsequently, the attention mechanism network can extract an embedding feature of a palm print image based on the corrected attention parameter. The embedding feature can be used for identifying an owner of a palm print in the palm print image. It can be learned that, the method provided in this embodiment can add, by using an attention degree of the attention mechanism network to the region in the first sample image, the predicted label to the region of the first sample image, and a definition of a definition type indicated by a predicted label added for a region with a higher attention degree may be higher. Further, the attention parameter may be corrected according to the difference between a real label (for example, the reference label) and the predicted label of the region. Subsequently, the attention mechanism network can adopt a higher attention degree for a region with a higher definition in the palm print image by using the corrected attention parameter, and adopt a lower attention degree for a region with a lower definition in the palm print image, so that an image feature of the region with the higher definition in the palm print image can be extracted to a greater extent, and finally a more accurate embedding feature of the palm print image is extracted. More accurate classification on the palm print image (that is, more accurate identification on an owner of the palm print in the palm print image) can be implemented by using the more accurate embedding feature of the palm print image.

### BRIEF DESCRIPTION OF THE DRAWINGS

FIG. 1 is a schematic structural diagram of a network architecture for palm print image processing according to an embodiment of this application.

FIG. 2 is a schematic diagram of a scenario of correcting a network parameter according to an embodiment of this application.

FIG. 3 is a schematic flowchart of an image processing method according to an embodiment of this application.

FIG. 4 is a schematic flowchart of training an image segmentation network according to an embodiment of this application.

FIG. 5 is a schematic diagram of a scenario of correcting an attention parameter according to an embodiment of this application.

FIG. 6 is a schematic flowchart of a network training method according to an embodiment of this application.

FIG. 7 is a schematic diagram of a scenario of training a palm print classification network according to an embodiment of this application.

FIG. 8 is a schematic diagram of a scenario of generating a target embedding feature according to an embodiment of this application.

FIG. 9 is a schematic diagram of a scenario of palm print prediction according to an embodiment of this application.

FIG. 10 is a schematic structural diagram of an image processing apparatus according to an embodiment of this application.

FIG. 11 is a schematic structural diagram of a computer device according to an embodiment of this application.

### DESCRIPTION OF EMBODIMENTS

This application relates to artificial intelligence-related technologies. Artificial intelligence (AI) is a theory, a method, a technology, and an application system that use a digital computer or a machine controlled by the digital computer to simulate, extend, and expand human intelligence, perceive an environment, obtain knowledge, and use knowledge to obtain an optimal result. In other words, the artificial intelligence is a comprehensive technology in computer science. The artificial intelligence attempts to understand an essence of intelligence, and produces a new intelligent machine that can react in a manner similar to the human intelligence. The artificial intelligence is to study the design principles and implementation methods of various intelligent machines, to enable the machines to have the functions of perception, reasoning, and decision-making.

The artificial intelligence technology is a comprehensive discipline, and relates to a wide range of fields, including both hardware-level technologies and software-level technologies. Basic technologies of the artificial intelligence usually include technologies such as a sensor, a dedicated artificial intelligence chip, cloud computing, distributed storage, big data processing technologies, an operating/interaction system, and electromechanical integration. The artificial intelligence software technologies mainly include several major directions such as a computer vision technology, a speech processing technology, a natural language processing technology, and machine learning/deep learning.

This application mainly relates to machine learning in artificial intelligence. Machine learning (ML) is a multi-domain interdisciplinary subject, relates to multi-domain subjects such as probability theory, statistics, approximation theory, convex analysis, and algorithm complexity theory, and specially studies how a computer simulates or implements a human learning behavior, to obtain new knowledge or skills, and reorganize an existing knowledge structure to continuously improve its performance. The machine learning, as a core of the artificial intelligence, is a fundamental way to make the computer intelligent, and is applied throughout various fields of the artificial intelligence. The machine learning and the deep learning usually include technologies such as an artificial neural network, a belief network, reinforcement learning, transfer learning, inductive learning, and demonstration learning.

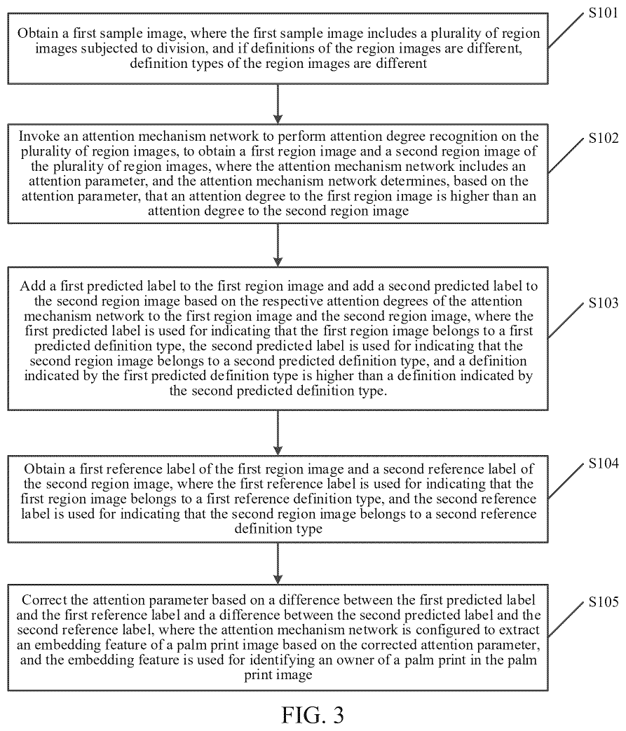

Machine learning involved in this application mainly refers to how to obtain a palm print classification network through training, to accurately classify a palm print category of a palm print image by using the trained palm print classification network. For a specific procedure, refer to the related descriptions in the embodiment corresponding to FIG. 3.

First, all data (all relevant data such as palm print images) acquired in this application are acquired with the consent and authorization of an object (such as a user, an institution, or an enterprise) to which the data belongs, and the acquisition, use, and processing of relevant data need to comply with the relevant laws, regulations, and standards of relevant countries and regions.

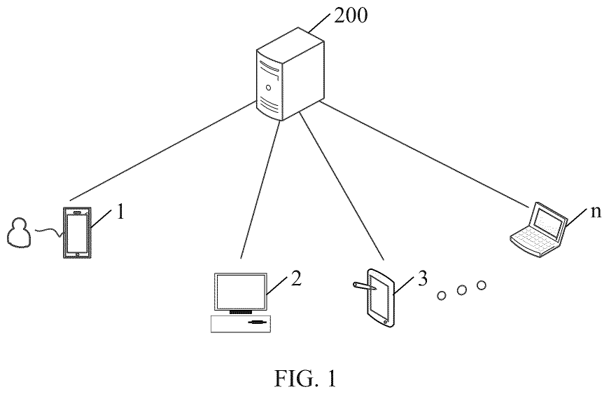

Referring to FIG. 1, FIG. 1 is a schematic structural diagram of a network architecture for palm print image processing according to an embodiment of this application. As shown in FIG. 1, the network architecture may include a server 200 and a terminal device cluster. The terminal device cluster may include one terminal device or a plurality of terminal devices. A quantity of terminal devices is not limited herein. As shown in FIG. 1, the plurality of terminal devices may specifically include a terminal device 1, a terminal device 2, a terminal device 3, . . . , and a terminal device n. As shown in FIG. 1, the terminal device 1, the terminal device 2, the terminal device 3, . . . , and the terminal device n may all be in a network connection with the server 200, so that each terminal device can exchange data with the server 200 through the network connection.

The server 200 shown in FIG. 1 may be an independent physical server, a server cluster or distributed system including a plurality of physical servers, or a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The terminal device may be an intelligent terminal such as a smartphone, a tablet computer, a notebook computer, a desktop computer, an in-vehicle terminal, or a smart television. Communication between the terminal device 1 and the server 200 is used as an example below to describe embodiments of this application in detail.

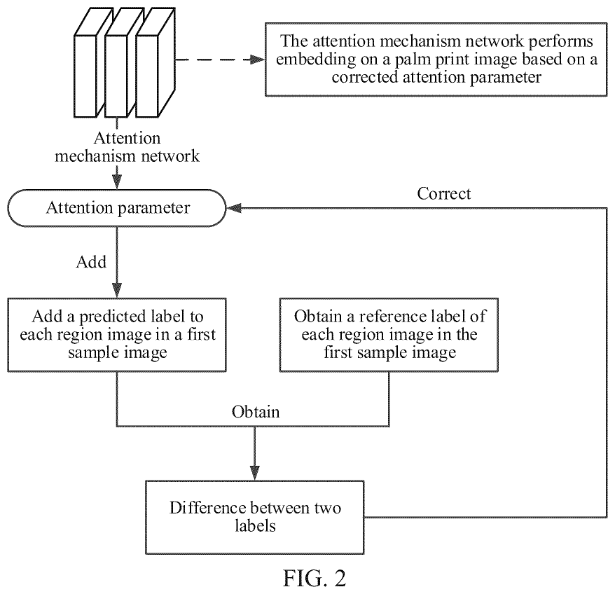

Referring to FIG. 2 together, FIG. 2 is a schematic diagram of a scenario of correcting a network parameter according to an embodiment of this application. As shown in FIG. 2, a server 200 may correct an attention parameter of an attention mechanism network by using a first sample image. The first sample image may include a plurality of regions (local images belonging to the first sample image). The attention mechanism network may determine attention degrees of regions in an input image (for example, the first sample image) by using the attention parameter.

Therefore, the server 200 may add a predicted label for each region in the first sample image by using the attention parameter of the attention mechanism network. The predicted label may be a label of a definition type of each region in the first sample image and determined by using the attention parameter of the attention mechanism network. For example, a region that the attention mechanism network pays more attention may be marked with a label of a definition type of a higher definition.

The server 200 may further obtain a reference label of each region in the first sample image. The reference label may be used for indicating an actual definition type of each region in the first sample image.

Therefore, the server 200 may correct the attention parameter of the attention mechanism network based on a difference between the predicted label and the reference label of each region in the first sample image, so that the attention mechanism network can pay more attention to a feature of an image of a clearer region in the input image by using the corrected attention parameter.

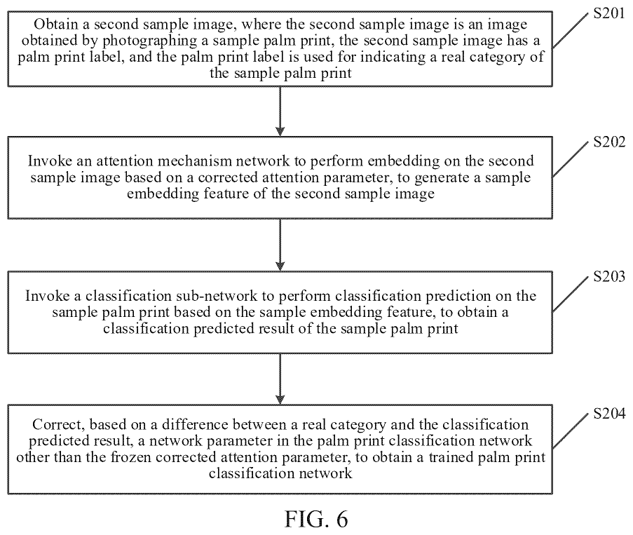

Subsequently, the attention mechanism network may be used as a network for extracting a feature of a palm print image in a palm print identification scenario. The attention mechanism network may perform embedding on an input palm print image by using the attention parameter corrected according to the foregoing manner, to generate an accurate embedding feature of the palm print image, and then accurate classification of a palm print category of the palm print image can be implemented by using the embedding feature. The palm print image may be an image obtained by the terminal device 1 by photographing a palm print of a user. The terminal device 1 may send the acquired palm print image to the server 200, to request the server 200 to classify a palm print category of the palm print image, so that the server 200 can invoke the attention mechanism network to classify the palm print category of the palm print image by using the corrected attention parameter. For a specific procedure, refer to the related descriptions in the following embodiments corresponding to FIG. 3 and FIG. 6.

By using the method in this embodiment of this application, the attention mechanism network can pay more attention to an image feature of a clearer region in an input palm print image, so that a more accurate embedding feature of the palm print image can be extracted, and more accurate classification on the palm print category of the palm print image can also be implemented by using the accurate embedding feature of the palm print image.

Referring to FIG. 3, FIG. 3 is a schematic flowchart of an image processing method according to an embodiment of this application. An execution body in this embodiment of this application may be an image processing device. The image processing device may be a computer device or a computer device cluster including a plurality of computer devices. The computer device may be a server, a terminal device, or another device. This is not limited. As shown in FIG. 3, the method may include the following operations.
Operation S101: Obtain a first sample image, where the first sample image comprises a plurality of regions subjected to division, and if definitions of the regions are different, definition types of the regions are different.

In an embodiment, the image processing device may obtain the first sample image. The first sample image may include a plurality of regions subjected to division. In other words, the first sample image may be divided into the plurality of regions, and each region may be a local image in the first sample image. In other words, the first sample image may be divided into a plurality of image blocks (namely, the plurality of regions), a size of each image block may be determined according to an actual application scenario (may be a preset division size), and sizes of the image blocks may be the same.

The plurality of regions may include regions having the same definition, or may include regions having different definitions (namely, image definitions). The definition of the image may refer to sharpness of change of an edge of image details, in other words, clarity of the image details and boundaries thereof. In this application, if definitions of the regions are different, it may be considered that definition types of the regions are different. The definition type of the image may be understood as a definition level of the image. The definition level may refer to a definition range obtained by dividing the definition of the image, and one definition level may correspond to one definition range. Each definition type of the image may be used for indicating a definition (an image definition) corresponding to the definition type, for example, used for indicating a definition level corresponding to the definition type. A higher definition level of the image indicates a higher definition indicated by the image (that is, the image is clearer). Otherwise, a lower definition level of the image indicates a lower definition indicated by the image (that is, the image is less clear).

For example, there may be at least two definition types of the image. The two may include a blurry definition type and a clear (or high definition) definition type. As the name implies, a definition (blurry definition) indicated by the blurry definition type is lower than a definition (clear definition) indicated by the clear definition type. Alternatively, on this basis, the definition type may be classified into finer definition types based on definition degrees. For example, definition types of the image may include a blurry (for example, low definition) definition type, a standard definition type, a high definition type, an ultra-high definition type, and the like. Definitions indicated by the definition types may be sequentially ascending. For example, a definition indicated by the standard definition type is higher than a definition indicated by the blurry definition type, a definition indicated by the high definition type is higher than the definition indicated by the standard definition type, and a definition indicated by the ultra-high definition type is higher than the definition indicated by the high definition type.

The categories of the definition types of the image and specific definition types included may be set arbitrarily according to an actual application scenario, and this is not limited. That the definitions of the regions are different means that the regions have different definition levels.

In other words, the first sample image may include regions of at least two definition types, and one region may have one definition type. A specific quantity of first sample images may be determined according to an actual application scenario.
Operation S102: Invoke an attention mechanism network to perform attention degree recognition on the plurality of regions, to obtain a first region and a second region of the plurality of regions, where the attention mechanism network comprises an attention parameter, and the attention mechanism network determines, based on the attention parameter, that an attention degree to the first region is higher than an attention degree to the second region.

In an embodiment of this application, the attention mechanism network may perform attention degree recognition on the input image (for example, the first sample image) in a unit of each region obtained by dividing the input image. Therefore, the image processing device may invoke the attention mechanism network to perform identification (for example, attention degree recognition) on the plurality of regions of the first sample image, to obtain the first region and the second region of the plurality of regions.

The attention mechanism network is a network (namely, a model) having an attention mechanism. A core idea of the attention mechanism is to simulate an attention process of human beings on an input of the network. To be specific, the network can automatically determine which part of input data needs to be concerned about when data processing is performed, so that the network can effectively capture key information of the input data. For example, the attention mechanism network includes, but is not limited to, a Transformer (a neural network based on a self-attention mechanism), a GAT (a graph attention mechanism network), and the like. The attention mechanism network may include an attention parameter (which belongs to a weight parameter, and is a network parameter of the attention mechanism network). The attention mechanism network may determine, by using the attention parameter, that an attention degree of the first region is higher than an attention degree (that is, a concern degree) of the second region, or in other words, the attention degree paid to the first region by the attention mechanism network is higher than attention degree paid to the second region. The attention degree paid to each region by the attention mechanism network may be determined by using the attention parameter of the attention mechanism network, as described in the following content.

The attention mechanism network may perform, by using the foregoing attention parameter, identification (that is, feature learning) on the first sample image in a unit of each region of the first sample image, to identify (that is, learn) an attention weight of the attention mechanism network for each region. The attention mechanism network may have one attention weight for one region, and the attention weight of the attention mechanism network for the region may be used for reflecting an attention degree of the attention mechanism network to the region. A higher attention weight indicates a higher attention degree. Otherwise, a lower attention weight indicates a lower attention degree. A value range of the attention weight may be [0, 1].

It can be learned from the above that, the attention mechanism network may obtain, by using the attention parameter and in a unit of each image block (that is, each region) of the first sample image, the attention weight of each image block of the first sample image. In other words, which image block of the input image (for example, the first sample image) is paid more attention by the attention mechanism network and which image block of the input image is paid less attention by the attention mechanism network can be learned by using the attention parameter of the attention mechanism network.

Optionally, the value range [0, 1] of the attention weight may be divided based on a quantity of definition types of the image, to obtain a plurality of weight ranges of the attention weight through division. One definition type may correspond to one weight range of the attention weight. A higher definition indicated by a definition type indicates a higher weight value in the weight range corresponding to the definition type. A combination of all weight ranges may be the entire value range [0, 1] of the attention weight.

For example, if there are two definition types of the image, including a blurry definition type and a clear definition type, the value range of the attention weight may be divided into two weight ranges, for example, divided into a weight range [0, 0.5) and a weight range [0.5, 1]. The weight range [0, 0.5) may be a weight range corresponding to the blurry definition type, the weight range [0.5, 1] may be a weight range corresponding to the clear definition type, and the weight ranges do not overlap each other.

Therefore, the attention weight of the first region and the attention weight of the second region may be respectively in the two weight ranges obtained through division, and the attention weight of the first region is greater than the attention weight of the second region, in other words, weight values in a weight range to which the attention weight of the first region belongs are greater than weight values in a weight range to which the attention weight of the second region belongs.

Any two weight ranges of the plurality of weight ranges obtained by dividing the value range of the attention weight may be referred to as a first weight range and a second weight range, and weight values in the first weight range are greater than weight values in the second weight range. For example, the weight range [0.5, 1] may be the first weight range, and the weight range [0, 0.5) may be the second weight range.

Therefore, in this application, a region of the plurality of regions of the first sample image and whose attention weight is in a first weight range can be used as the first region, and a region of the plurality of regions whose attention weight is in a second weight range can be used as the second region. There may be one or more first regions and second regions, and specific quantities of the first regions and the second regions may be determined according to an actual application scenario.

In this embodiment, regions (to be specific, the first region and the second region) of two definition types are used as an example for description. Actually, regions of all definition types may be (or need to be) processed in a same processing manner, to correct the attention parameter of the attention mechanism network. For example, when an image has more than two definition types, there may also be more than two weight ranges. The attention weight of the attention mechanism network for the first region and the attention weight of the attention mechanism network for the second region may be respectively in different weight ranges. The first region and the second region may be regions whose attention weights are in any two weight ranges of the more than two weight ranges. In addition, weight values in the weight range to which the attention weight of the attention mechanism network for the first region belongs is greater than weight values in the weight range to which the attention weight of the attention mechanism network for the second region belongs. In other words, regions with attention weights falling within two weight ranges of the more than two weight ranges may be respectively used as the corresponding first region and second region, to perform the related processing in this embodiment of this application.

For example, if there are three definition types of the image, including a blurry definition type, a standard definition type, and a clear definition type, the value range of the attention weight may be divided into three weight ranges, for example, may be divided into a weight range [0, 0.33), a weight range [0.33, 0.66), and a weight range [0.66, 1]. The weight range [0, 0.33) may correspond to the blurry definition type, the weight range [0.33, 0.66) may correspond to the standard definition type, and the weight range [0.66, 1] may correspond to the clear definition type.

For a region whose attention weight is within the weight range [0, 0.33) and a region whose attention weight is within the weight range [0.33, 0.66), the region whose attention weight is within the weight range [0, 0.33) may be used as the second region, and the region whose attention weight is within the weight range [0.33, 0.66) may be used as the first region, to perform the related processing described in this embodiment of this application.

For a region whose attention weight is within the weight range [0.33, 0.66) and a region whose attention weight is within the weight range [0.66, 1], the region whose attention weight is within the weight range [0.33, 0.66) may be used as the second region, and the region whose attention weight is within the weight range [0.66, 1] may be used as the first region, to perform the related processing described in this embodiment of this application.

Moreover, for a region whose attention weight is within the weight range [0, 0.33) and a region whose attention weight is within the weight range [0.66, 1], the region whose attention weight is within the weight range [0, 0.33) may be used as the second region, and the region whose attention weight is within the weight range [0.66, 1] may be used as the first region, to perform the related processing described in this embodiment of this application.

When there are more than three definition types of the image, corresponding processing may also be performed according to the foregoing principle. A specific quantity of definition types of the image and a quantity of weight ranges that need to be obtained through division can both be determined according to an actual application scenario. This is not limited in this application.
Operation S103: Add a first predicted label to the first region and add a second predicted label to the second region based on the respective attention degrees of the attention mechanism network to the first region and the second region, where the first predicted label is used for indicating that the first region belongs to a first predicted definition type, the second predicted label is used for indicating that the second region belongs to a second predicted definition type, and a definition indicated by the first predicted definition type is higher than a definition indicated by the second predicted definition type.

In an embodiment, the image processing device may add a corresponding predicted label for each region by using a weight range to which an attention weight of the attention mechanism network for each region belongs and a definition type corresponding to each weight range, as described in the following content.

The image processing device may add the first predicted label to the first region by using the attention weight (namely, the attention degree) of the attention mechanism network to the first region. For example, the image processing device may add the first predicted label for the first region by using the definition type corresponding to the weight range to which the attention weight of the first region belongs. The first predicted label may be used for indicating that the definition type of the first region belongs to the first predicted definition type, and the first predicted definition type is a definition type corresponding to the weight range to which the attention weight of the first region belongs. The first predicted definition type may be understood as a definition type determined (that is, predicted) by the attention mechanism network for the first region based on the attention parameter.

Similarly, the image processing device may add the second predicted label to the second region by using the attention weight (namely, the attention degree) of the attention mechanism network to the second region. For example, the image processing device may add the second predicted label for the second region by using the definition type corresponding to the weight range to which the attention weight of the second region belongs. The second predicted label may be used for indicating that the definition type of the second region belongs to the second predicted definition type, and the second predicted definition type is a definition type corresponding to the weight range to which the attention weight of the second region belongs. The second predicted definition type may be understood as a definition type determined (that is, predicted) by the attention mechanism network for the second region based on the attention parameter.

In addition, an image definition indicated by the first predicted definition type is higher than an image definition indicated by the second predicted definition type.

By using the foregoing process of adding the predicted label (including the first predicted label and the second predicted label) for the first region and the second region, in this embodiment, a predicted label of a definition type indicating a higher definition may be added for a region that the attention mechanism network pays more attention. Subsequently, the attention parameter of the attention mechanism network is corrected in this manner, so that the attention mechanism network may pay more attention to a clearer region in the input image and pay less attention to a blurrier region in the input image based on the corrected attention parameter.
Operation S104: Obtain a first reference label of the first region and a second reference label of the second region, where the first reference label is used for indicating that the first region belongs to a first reference definition type, and the second reference label is used for indicating that the second region belongs to a second reference definition type.

In an embodiment, the image processing device may obtain the reference label of the first region and the reference label of the second region. The reference label of the first region may be referred to as the first reference label, and the reference label of the second region may be referred to as the second reference label.

The first reference label may be a label of an actual definition type of the first region, and the second reference label may be a label of an actual definition type of the second region.

The first reference label may be used for indicating that the definition type of the first region belongs to the first reference definition type, that is, the actual definition type of the first region may be the first reference definition type. Similarly, the second reference label may be used for indicating that the definition type of the second region belongs to the second reference definition type, that is, the actual definition type of the second region may be the second reference definition type.

The first reference definition type and the second reference definition type each may be any one of the at least two definition types set for the image.

In an embodiment, the first reference label of the first region and the second reference label of the second region may be obtained by using a trained definition classification network, as described in the following content:

The image processing device may invoke the trained definition classification network to perform classification prediction on a definition of the first region, to obtain the first reference definition type of the first region. The first reference definition type is an actual definition type of the first region predicted by using the trained definition classification network.

Similarly, the image processing device may invoke the trained definition classification network to perform classification prediction on a definition of the second region, to obtain the second reference definition type of the second region. The second reference definition type is an actual definition type of the second region predicted by using the trained definition classification network.

Therefore, the image processing device can add the first reference label for the first region by using the first reference definition type. The first reference label is used for indicating that the definition type of the first region is the first reference definition type.

The image processing device may further add the second reference label for the second region by using the second reference definition type. The second reference label is used for indicating that the definition type of the second region is the second reference definition type.

For example, a process of obtaining the trained definition classification network through training may include: The image classification network may obtain a third sample image and a definition classification network that needs to be trained, where the third sample image has a definition label, and the definition label is used for indicating a real definition type of the third sample image (that is, an actual definition type of the third sample image). In an embodiment of this application, there may be several third sample images. The several third sample images may include sample images of various definition types (including all definition types preconfigured for the image), and are used for training the definition classification network that needs to be trained.

Further, the image processing device may invoke the definition classification network that needs to be trained, and perform classification prediction on the definition type of the third sample image, to obtain a predicted definition type of the third sample image. The predicted definition type is the definition type of the third sample image obtained through prediction by using the definition classification network that needs to be trained.

Then, the image processing device may correct a network parameter of the definition classification network that needs to be trained based on a difference (which may be reflected by a cross entropy loss between the real definition type and the predicted definition type) between the real definition type and the predicted definition type of the third sample image, to obtain the trained definition classification network.

Moreover, the image processing device may further invoke a trained image segmentation network, to obtain the first reference label of the first region and the second reference label of the second region. The process may include the following operations:

The trained image segmentation network is a network obtained through training and that can be used for segmenting parts of images with different definition types in the input image. For example, the trained image segmentation network may include, but is not limited to, U-Net (a convolutional neural network). Therefore, the image processing device may invoke the trained image segmentation network to perform image segmentation on the first sample image, to obtain a plurality of segmented images of the first sample image. Each segmented image may be a local image in the first sample image. One segmented image may correspond to one definition type, that is, one segmented image has one definition type. The definition type corresponding to each segmented image may alternatively be obtained through identification by the trained image segmentation network when performing segmentation to obtain the segmented image.

Further, the image processing device may use a segmented image having the highest coincidence degree (that is, having the largest image coincidence regions) with the first region in the plurality of segmented images as a first definition matching image of the first region, and further, may add the first reference label for the first region based on a definition type corresponding to the first definition matching image. The first reference definition type indicated by the first reference label may be the definition type corresponding to the first definition matching image.

Similarly, the image processing device may use a segmented image having the highest coincidence degree (that is, having the largest image coincidence regions) with the second region in the plurality of segmented images as a second definition matching image of the second region, and further, may add the second reference label for the second region based on a definition type corresponding to the second definition matching image. The second reference definition type indicated by the second reference label may be the definition type corresponding to the second definition matching image.

In an embodiment, the image processing device may use either of the foregoing two manners (the manner based on the trained definition classification network and the manner based on the trained image segmentation network) to pre-add a corresponding reference label for each region in the first sample image, so that in operation S104, the reference label (including the first reference label and the second reference label) pre-added for the first region and the second region can be directly obtained.

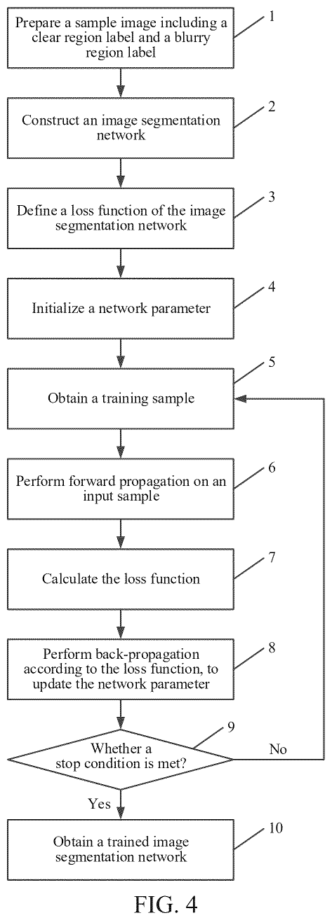

Referring to FIG. 4, FIG. 4 is a schematic flowchart of training an image segmentation network according to an embodiment of this application. As shown in FIG. 4, the procedure may include the following operations.
1. It is assumed that definition types set for an image includes a clear definition type and a blurry definition type, and therefore, the image processing device may prepare a sample image including a clear region label and a blurry region label. The clear region label may be a label for an image of a clear region in the sample image, and the clear region label is a label of the clear definition type. The blurry region label may be a label for an image of a blurry region in the sample image, and the blurry region label is a label of the blurry definition type.
2. The image processing device may construct an image segmentation network. For example, the image processing device may construct a U-Net network as the image segmentation network.
3. The image processing device may define a loss function of the image segmentation network. For example, the loss function may be a cross-entropy loss between a predicted clear region and a predicted fuzzy region and an actual clear region and an actual blurry region indicated by region labels (including the clear region label and the blurry region label) marked for the sample image.
4. The image processing device may perform initialization on a network parameter of the image segmentation network, for example, perform random initialization, to further start training the image segmentation network.
5. The image processing device may obtain a sample (belonging to the sample image prepared in operation 1) for training the image segmentation network in a current round.
6. The image processing device may input an obtained sample into the image segmentation network for forward propagation, to predict and identify a clear region and a blurry region in the input sample image.
7. The image processing device may calculate the loss function of the image segmentation network based on a difference (which may be reflected by a cross-entropy loss) between a clear region obtained through prediction and identification and the actual clear region marked by the clear region label, and a difference (which may be reflected by a cross-entropy loss) between a blurry region obtained through prediction and identification and the actual blurry region marked by the blurry region label.
8. The image processing device may perform back propagation in the image segmentation network by using the calculated loss function, to correct (that is, update) the network parameter of the image segmentation network.
9. The image processing device may determine whether a stop condition is currently met. The stop condition may be a condition for determining whether the image segmentation network is trained. For example, the stop condition may be that the network parameter of the image segmentation network is trained to a convergent state, or the stop condition may be that a round number of iterative training on the image segmentation network is greater than or equal to a quantity threshold, and the like. Therefore, if the stop condition is met, the image processing device may perform the following operation 10, or if the stop condition is not met, the image processing device may repeatedly perform the foregoing operation 5, to start a next round of iterative training on the image segmentation network.
10. Use the image segmentation network obtained through training at this time as the trained image segmentation network.
Operation S105: Correct the attention parameter based on a difference between the first predicted label and the first reference label and a difference between the second predicted label and the second reference label, where the attention mechanism network is configured to extract an embedding feature of a palm print image based on the corrected attention parameter, and the embedding feature is used for identifying an owner of a palm print in the palm print image.

Optionally, the image processing device may correct the attention parameter of the attention mechanism network based on the difference between the first predicted label and the first reference label, and the difference between the second predicted label and the second reference label. The difference between the first predicted label and the first reference label may be reflected by a cross-entropy loss between the first predicted label and the first reference label, and the difference between the second predicted label and the second reference label may be reflected by a cross-entropy loss between the second predicted label and the second reference label.

In other words, the attention parameter of the attention mechanism network may be modified based on the cross-entropy loss between the first predicted label and the first reference label and the cross-entropy loss between the second predicted label and the second reference label (for example, a sum of the two cross-entropies). An objective of the correction may be to make the sum of the cross-entropy tend to be a minimum value (for example, 0).

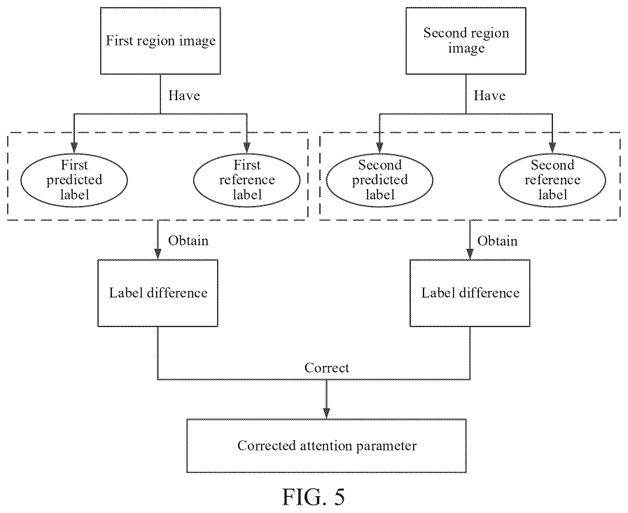

Referring to FIG. 5, FIG. 5 is a schematic diagram of correcting an attention parameter according to an embodiment of this application. As shown in FIG. 5, the first region may have a first predicted label and a first reference label, and the second region may have a second predicted label and a second reference label.

The image processing device may obtain a difference between the first predicted label and the first reference label of the first region. For example, the difference may be a cross-entropy loss between the first predicted label and the first reference label. In other words, the cross-entropy loss may be used for reflecting the difference between the first predicted label and the first reference label. The image processing device may further obtain a difference between the second predicted label and the second reference label of the second region. For example, the difference may be a cross-entropy loss between the second predicted label and the second reference label. In other words, the cross-entropy loss may be used for reflecting/representing the difference between the second predicted label and the second reference label.

Further, the image processing device may correct the attention parameter of the attention mechanism network by using the cross-entropy loss between the first predicted label and the first reference label, and the cross-entropy loss between the second predicted label and the second reference label that are obtained above, to obtain the corrected attention parameter.

Based on the foregoing principle, the attention mechanism network, by using the corrected attention parameter, can pay more attention to a region having a higher definition in an input image (such as a palm print image), and pay less attention to a region having a lower definition in the input image. Therefore, subsequently, the attention mechanism network can more accurately extract an embedding feature of the palm print image by using the corrected attention parameter. The accurate embedding feature can be used for more accurately classifying a palm print category (such as an owner of a palm print in the palm print image) of the palm print image. The process of classifying the palm print category of the palm print image is a process of identifying the owner of the palm print in the palm print image (for example, identifying a user to which the palm print in the palm print image specifically belongs, to determine an identity of the owner of the palm print in the palm print image). For the specific process, refer to the related descriptions in the following embodiment corresponding to FIG. 6.

In this application, a first sample image can be obtained. The first sample image comprises a plurality of regions subjected to division, and if definitions of the regions are different, definition types of the regions are different. In addition, an attention mechanism network can be invoked to perform attention degree recognition on the plurality of regions, to obtain a first region and a second region of the plurality of regions. The attention mechanism network comprises an attention parameter, and the attention mechanism network determines, based on the attention parameter, that an attention degree to the first region is higher than an attention degree to the second region. Further, a first predicted label can be added to the first region and a second predicted label can be added to the second region based on the respective attention degrees of the attention mechanism network to the first region and the second region. The first predicted label is used for indicating that the first region belongs to a first predicted definition type, the second predicted label is used for indicating that the second region belongs to a second predicted definition type, and a definition indicated by the first predicted definition type is higher than a definition indicated by the second predicted definition type. A first reference label of the first region and a second reference label of the second region can be obtained. The first reference label is used for indicating that the first region actually belongs to a first reference definition type, and the second reference label is used for indicating that the second region actually belongs to a second reference definition type. Therefore, the attention parameter can be corrected based on a difference between the first predicted label and the first reference label and a difference between the second predicted label and the second reference label. The attention mechanism network is configured to extract an embedding feature of a palm print image based on the corrected attention parameter. The embedding feature is used for identifying an owner of a palm print in the palm print image. It can be learned that, the method provided in this embodiment can add, by using an attention degree of the attention mechanism network to the region in the first sample image, the predicted label to the region of the first sample image, and a definition of a definition type indicated by a predicted label added for a region with a higher attention degree may be higher. Further, the attention parameter may be corrected according to the difference between a real label (for example, the reference label) and the predicted label of the region. Subsequently, the attention mechanism network can adopt a higher attention degree for a region with a higher definition in the palm print image by using the corrected attention parameter, and adopt a lower attention degree for a region with a lower definition in the palm print image, so that an image feature of the region with the higher definition in the palm print image can be extracted to a greater extent, and finally a more accurate embedding feature of the palm print image is extracted. More accurate classification on the palm print image (that is, more accurate identification on an owner of the palm print in the palm print image) can be implemented by using the more accurate embedding feature of the palm print image.

Referring to FIG. 6, FIG. 6 is a schematic flowchart of a network training method according to an embodiment of this application. This application may be applied to a palm print recognition scenario. As shown in FIG. 6, the method may include the following operations:
Operation S201: Obtain a second sample image, where the second sample image is an image obtained by photographing a sample palm print, the second sample image has a palm print label, and the palm print label is used for indicating a real category of the sample palm print.

In an embodiment, the image processing device may further obtain the second sample image. The second sample image may be an image obtained by photographing the sample palm print (which may be a palm print of any user). The second sample image may have the palm print label. The palm print label may be used for indicating the real category of the sample palm print. The real category may be used for indicating an actual owner of the sample palm print (for example, a user to which the sample palm print actually belongs, that is, a user of the palm print).

The attention mechanism network may be included in a palm print classification network. The attention parameter (namely, the corrected attention parameter) obtained by correcting the attention parameter of the attention mechanism network by using the process described in the foregoing embodiment corresponding to FIG. 3 may be frozen in the palm print classification network, so that in a subsequent process of training the palm print classification network, the corrected attention parameter does not need to be corrected again. The palm print classification network may be a network configured to identify (that is, classify) the palm print in the palm print image, to identify the owner of the palm print in the palm print image (for example, the user to which the palm print belongs). For example, the palm print classification network includes, but is not limited to, a decision tree model, a support vector machine model, and the like.

In other words, the process in the foregoing embodiment corresponding to FIG. 3 may be understood as a previous operation of correcting the attention parameter of the attention mechanism network in the palm print classification network. After the attention parameter of the attention mechanism network in the palm print classification network is corrected, overall training may be performed on the palm print classification network. In the training process, the corrected attention parameter may not be updated, but a network parameter other than the corrected attention parameter in the palm print classification network may be updated, as described in the following content.
Operation S202: Invoke the attention mechanism network to perform embedding on the second sample image based on the corrected attention parameter, to generate a sample embedding feature of the second sample image.

In an embodiment, the attention mechanism network may belong to a sub-network in the palm print classification network that is configured to extract a feature from the input image. In addition to the corrected attention parameter, network parameters of the attention mechanism network may further include another network parameter used for performing embedding (that is, feature extraction) on the input image.

Therefore, the image processing device may invoke the foregoing attention mechanism network in the palm print classification network, perform embedding (that is, feature extraction) on the second sample image (to be specific, the input image of the attention mechanism network in this case) based on the foregoing corrected attention parameter and the another network parameter used for performing embedding on the input image, and may generate the sample embedding feature of the second sample image. In an embodiment, the sample embedding feature may be a feature vector. The sample embedding feature is a feature obtained by the attention mechanism network by learning the second sample image.

In an embodiment, there may be a plurality of second sample images, the plurality of second sample images may be images obtained by photographing the sample palm print from a plurality of photographing angles, and one photographing angle is used for photographing to obtain one second sample image of the sample palm print. Therefore, the process of generating the sample embedding feature in this application may include the following operations:

The image processing device may invoke the attention mechanism network to separately perform embedding on each second sample image based on the corrected attention parameter and the another network parameter used for performing embedding on the input image, to generate an image embedding feature of each second sample image. One second sample image may have an image embedding feature, and the image embedding feature of the second sample image is a feature learned by the attention mechanism network from the second sample image.

Further, the image processing device may fuse image embedding features of a plurality of second sample images, to generate the sample embedding feature. The sample embedding feature may be a feature obtained by fusing features of images (for example, the plurality of second sample images) of the sample palm print photographed from a plurality of angles.

Because the second sample images photographed from the photographing angles may include images of different clear regions of the sample palm print, the sample embedding feature is obtained by fusing the second sample images obtained from the photographing angles, so that the sample embedding feature includes features of the images of the clear regions of the sample palm print from the different photographing angles. In addition, the features of the images of the clear regions are more accurate than features of images of blurry regions. Therefore, the sample embedding feature generated in this manner is more accurate, and more accurate classification on the palm print category of the second sample image can also be implemented by using the sample embedding feature subsequently.

In an embodiment, the manner of fusing the image embedding features of the plurality of second sample images includes, but is not limited to, the following manner: stitching (for example, horizontal stitching) the image embedding features of the plurality of second sample images, to generate the sample embedding feature; or summing the image embedding features of the plurality of second sample images, to generate the sample embedding feature. Optionally, the generated sample embedding feature may also be a feature vector.

The process of summing the image embedding features of the plurality of second sample images may include: Dimensions of the image embedding features of the second sample images may be the same, and therefore, feature values on a same position in the image embedding features of the second sample images may be added together, to generate the sample embedding feature.
Operation S203: Invoke a classification sub-network to perform classification prediction on the sample palm print based on the sample embedding feature, to obtain a classification predicted result of the sample palm print.

In an embodiment, the palm print classification network may further include the classification sub-network. The classification sub-network may be configured to classify a palm print in the palm print image, to output a probability (which may constitute a probability distribution) that the palm print in the palm print image belongs to each user (which may be referred to as an object) in a user set (which may be a full set of users that need to be identified in an application scenario of palm print identification). In an embodiment, the classification sub-network may be a fully connected network.

Therefore, the palm print classification network may invoke the classification sub-network to perform classification prediction on the sample palm print by using the foregoing sample embedding feature, to obtain the classification predicted result of the sample palm print. The classification predicted result may be a probability distribution (which may be represented as a vector) formed by the predicted probability that the sample palm print belongs to each of the users in the user set.
Operation S204: Correct, based on a difference between the real category and the classification predicted result, a network parameter in the palm print classification network other than the frozen corrected attention parameter, to obtain a trained palm print classification network.

In an embodiment, the image processing device may correct network parameters (which may include a network parameter used for embedding the image and a network parameter of the classification sub-network that are of the attention mechanism network and other than the corrected attention parameter) other than the frozen corrected attention parameter in the palm print classification network by using a difference (which may be represented by a cross-entropy loss) between the real category (which may also be represented as a vector, and in the vector, a probability at a position of a user indicated by the real category may be 1, and a probability at a position of another user may be 0) and the classification predicted result of the sample palm print, to obtain the trained palm print classification network.

For example, iterative training may be continuously performed on the palm print classification network by using the foregoing process, until the network parameters (the network parameters other than the frozen corrected attention parameter) of the palm print classification network reaches a convergent state, or a quantity of iterative training times on the palm print classification network is greater than or equal to a quantity threshold. In this case, the palm print classification network obtained through training may be used as the trained palm print classification network.

An attention mechanism network in the trained palm print classification network is the trained attention mechanism network, and a classification sub-network in the trained palm print classification network is the trained classification sub-network.

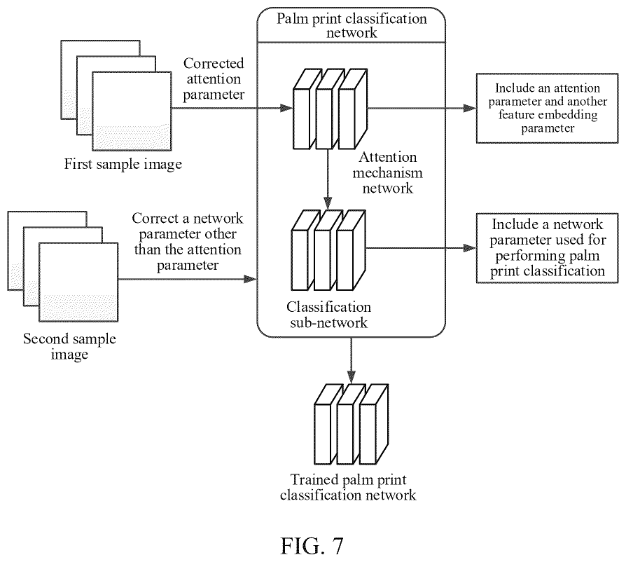

Referring to FIG. 7. FIG. 7 is a schematic diagram of a scenario of training a palm print classification network according to an embodiment of this application. As shown in FIG. 7, first, the image processing device may correct the attention parameter of the attention mechanism network in the palm print classification network by using the first sample image.

Further, network parameters (including feature embedding features of the attention mechanism network other than the corrected attention parameter, and the network parameter of the classification sub-network used for performing palm print classification) other than the corrected attention parameter in the palm print classification network may be corrected by using the second sample image, and finally the trained palm print classification network may be obtained.

Through the foregoing process, the palm print classification network can be obtained through training, and the trained palm print classification network may include a trained attention mechanism network and a trained classification sub-network. Subsequently, accurate classification on the palm print image can be implemented by using the trained palm print classification network, as described in the following content.

The image processing device may obtain a to-be-classified palm print image, and the palm print image may be an image obtained by photographing a target palm print (which may be a palm print of any user). In an embodiment, there may alternatively be a plurality of to-be classified palm print images, the plurality of palm print images may be images obtained by photographing the target palm print from a plurality of photographing angles, and one photographing angle may be used for photographing to obtain one palm print image of the target palm print.

The image processing device may invoke the trained attention mechanism network to perform embedding on the to-be-classified palm print image, to generate a target embedding feature of the to-be-classified palm print image. A generation principle of the target embedding feature is the same as that of the sample embedding feature, and may include:

The image processing device may invoke the trained attention mechanism network to separately perform embedding on each to-be-classified palm print image, to generate an image embedding feature of the palm print image, and may further fusing (for example, stitching or summing) image embedding features of a plurality of to-be-classified palm print images, to generate the target embedding feature.

Because the trained attention mechanism network includes the corrected attention parameter, the trained attention mechanism network can pay more attention to an image of a clear region in the palm print image by using the corrected attention parameter. Therefore, a more accurate target embedding feature of the to-be-classified palm print image can be generated.

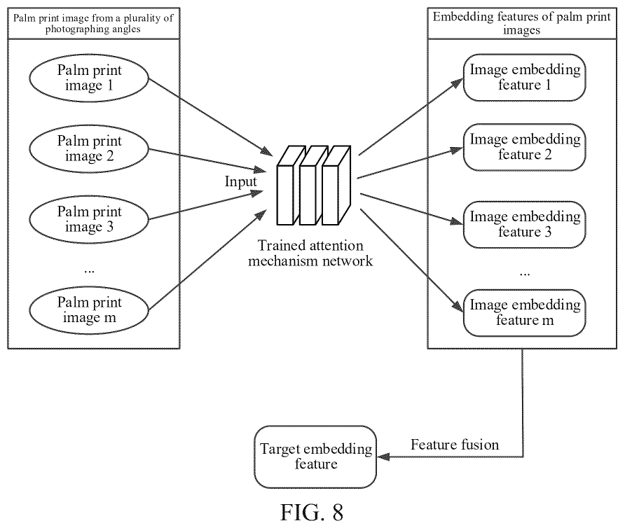

Referring to FIG. 8, FIG. 8 is a schematic diagram of a scenario of generating a target embedding feature according to an embodiment of this application. As shown in FIG. 8, the to-be-classified palm print images may include a palm print image 1 to a palm print image m obtained by photographing from a plurality of photographing angles, and the image processing device may invoke the trained attention mechanism network to perform embedding on the to-be-classified palm print images, to generate an image embedding feature 1 of the palm print image 1, an image embedding feature 2 of a palm print image 2, an image embedding feature 3 of a palm print image 3, . . . , and an image embedding feature m of the palm print image m.

Further, feature fusion may be performed on the image embedding feature 1, the image embedding feature 2, the image embedding feature 3, . . . , and the image embedding feature m that are generated, to generate the target embedding feature.

Further, the image processing device may invoke the trained classification sub-network to perform classification prediction on the target palm print by using the generated target embedding feature, to obtain a target category of the target palm print. The target category may represent a user corresponding to a maximum probability predicted by the trained classification sub-network in probabilities that the target palm print belongs to users in the user set. The user is an owner of the predicted target palm print, that is, the target category may be used for indicating the owner of the target palm print obtained through classification.

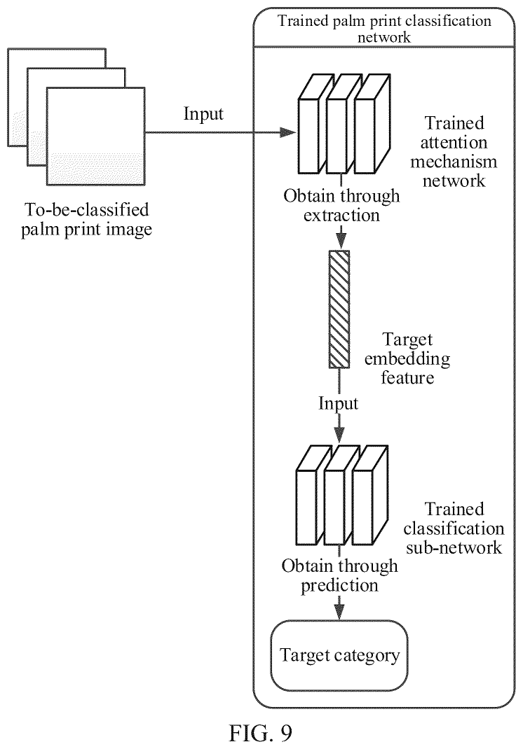

Referring to FIG. 9, FIG. 9 is a schematic diagram of a scenario of palm print prediction according to an embodiment of this application. As shown in FIG. 9, the image processing device may input the to-be-classified palm print image to the trained palm print classification network, to invoke the trained attention mechanism network in the trained palm print classification image to extract the target embedding feature of the to-be-classified palm print image.

Further, the trained classification sub-network in the trained palm print classification image may be invoked to obtain the target category of the target palm print in the to-be-classified palm print image through classification prediction by using the generated target embedding feature.

In a feasible implementation, the palm print image may be a palm print image photographed in real time by using a palm print capturing device (for example, a device that initiates an execution request for a target service) after a service initiator (which may be a service account, and the service account may belong to a service user) initiates (for example, initiates in a service platform) the execution request for the target service.

Therefore, if the target type is used for indicating that the owner of the target palm print is the service initiator (that is, a service user to which the service initiator belongs), the target service may be executed (dealt) for the service initiator, that is, the target service is provided for the service initiator.

Through the foregoing process, after accurate classification and identification of the palm print image is implemented, corresponding security processing can be performed on a related service.

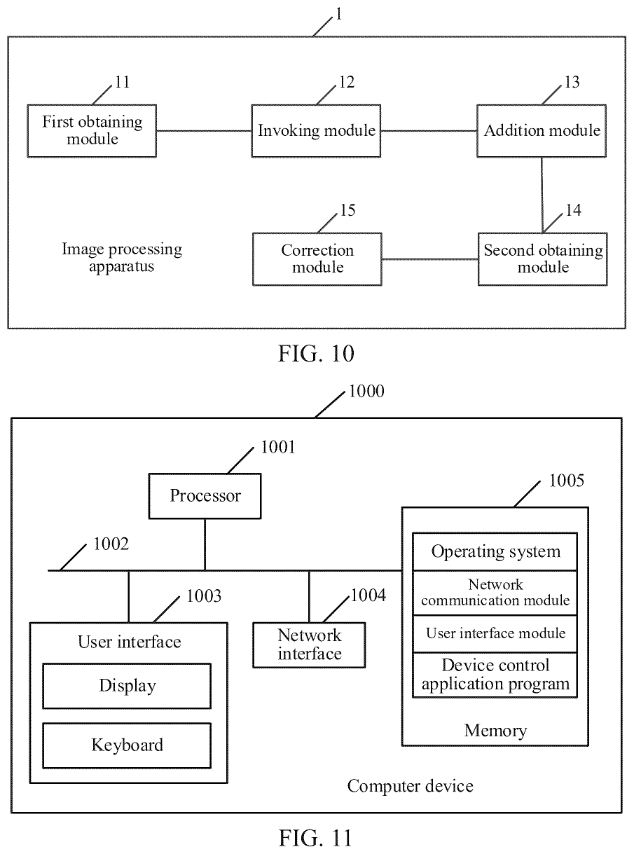

Referring to FIG. 10, FIG. 10 is a schematic structural diagram of an image processing apparatus according to an embodiment of this application. As shown in FIG. 10, the image processing apparatus 1 may include: a first obtaining module 11, an invoking module 12, an addition module 13, a second obtaining module 14, and a correction module 15.

The first obtaining module 11 is configured to obtain a first sample image, the first sample image comprising a plurality of regions subjected to division, and if definitions of the regions are different, definition types of the regions being different.

The invoking module 12 is configured to invoke an attention mechanism network to perform attention degree recognition on the plurality of regions, to obtain a first region and a second region of the plurality of regions, the attention mechanism network comprising an attention parameter, and the attention mechanism network determining, based on the attention parameter, that an attention degree to the first region is higher than an attention degree to the second region.

The addition module 13 is configured to add a first predicted label to the first region and add a second predicted label to the second region based on the respective attention degrees of the attention mechanism network to the first region and the second region, the first predicted label being used for indicating that the first region belongs to a first predicted definition type, the second predicted label being used for indicating that the second region belongs to a second predicted definition type, and a definition indicated by the first predicted definition type being higher than a definition indicated by the second predicted definition type.

The second obtaining module 14 is configured to obtain a first reference label of the first region and a second reference label of the second region, the first reference label being used for indicating that the first region belongs to a first reference definition type, and the second reference label being used for indicating that the second region belongs to a second reference definition type.

The correction module 15 is configured to correct the attention parameter based on a difference between the first predicted label and the first reference label and a difference between the second predicted label and the second reference label, the attention mechanism network being configured to extract an embedding feature of a palm print image based on the corrected attention parameter, and the embedding feature being used for identifying an owner of a palm print in the palm print image.

In an embodiment, the manner in which the invoking module 12 invokes the attention mechanism network to perform attention degree recognition on the plurality of regions, to obtain the first region and the second region includes:
invoking the attention mechanism network to determine an attention weight of each region of the plurality of regions based on the attention parameter, an attention weight of any region being used for reflecting an attention degree of the attention mechanism network to the region; and
using a region of the plurality of regions whose attention weight is in a first weight range as the first region, and using a region of the plurality of regions whose attention weight is in a second weight range as the second region;
a weight value in the first weight range being greater than a weight value in the second weight range.

In an embodiment, the attention mechanism network is comprised in a palm print classification network, the corrected attention parameter is frozen in the palm print classification network, the palm print classification network further comprises classification sub-network, and the apparatus 1 is further configured to:
obtain a second sample image, the second sample image being an image obtained by photographing a sample palm print, the second sample image having a palm print label, and the palm print label being used for indicating a real category of the sample palm print;
invoke the attention mechanism network to perform embedding on the second sample image based on the corrected attention parameter, to generate a sample embedding feature of the second sample image;
invoke the classification sub-network to perform classification prediction on the sample palm print based on the sample embedding feature, to obtain a classification predicted result of the sample palm print; and
correct, based on a difference between the real category and the classification predicted result, a network parameter in the palm print classification network other than the frozen corrected attention parameter, to obtain a trained palm print classification network.

In an embodiment, there are a plurality of second sample images, the plurality of second sample images are images obtained by photographing the sample palm print from a plurality of photographing angles, and one photographing angle is used for photographing to obtain one second sample image of the sample palm print.

A manner in which the apparatus 1 invokes the attention mechanism network to perform embedding on the second sample image based on the corrected attention parameter, to generate a sample embedding feature of the second sample image comprises:
invoking the attention mechanism network to separately perform embedding on each second sample image based on the corrected attention parameter, to generate an image embedding feature of the second sample image; and
fusing image embedding features of the plurality of second sample images, to generate the sample embedding feature.

In an embodiment, a manner in which the apparatus 1 fuses image embedding features of the plurality of second sample images, to generate the sample embedding feature includes:
stitching the image embedding features of the plurality of second sample images, to generate the sample embedding feature; or
summing the image embedding features of the plurality of second sample images, to generate the sample embedding feature.

In an embodiment, the trained palm print classification network comprises a trained attention mechanism network and a trained classification sub-network, and the apparatus 1 is further configured to:
obtaining a to-be-classified palm print image, the palm print image being an image obtained by photographing a target palm print;
invoking the trained attention mechanism network, to perform embedding on the palm print image, to generate a target embedding feature of the palm print image; and
invoking the trained classification sub-network to perform classification prediction on the target palm print based on the target embedding feature, to obtain a target category of the target palm print.

In an embodiment, there are a plurality of palm print images, the plurality of palm print images are images obtained by photographing the target palm print from a plurality of photographing angles, and one photographing angle is used for photographing to obtain one palm print image of the target palm print.

A manner in which the apparatus 1 invokes the trained attention mechanism network, to perform embedding on the palm print image, to generate a target embedding feature of the palm print image comprises:
invoking the trained attention mechanism network, to separately perform embedding on each palm print image, to generate an image embedding feature of the palm print image; and
fusing image embedding features of the plurality of palm print images, to generate the target embedding feature.

In an embodiment, the target category is used for indicating an owner of the target palm print, and the palm print image is obtained through photographing after a service initiator initiates an execution request for a target service.

The apparatus 1 is further configured to:

execute the target service on the service initiator if the target category is used for indicating that the owner of the target palm print is the service initiator.

In an embodiment, a manner in which the second obtaining module 14 obtains a first reference label of the first region and a second reference label of the second region includes:
invoking a trained definition classification network to perform classification prediction on a definition of the first region, to obtain a first reference definition type of the first region;
invoking the trained definition classification network to perform classification prediction on a definition of the second region, to obtain a second reference definition type of the second region; and
adding the first reference label for the first region based on the first reference definition type, and adding the second reference label for the second region based on the second reference definition type.

In an embodiment, the apparatus 1 is further configured to:
obtain a third sample image and a definition classification network that needs to be trained, the third sample image having a definition label, and the definition label being used for indicating a real definition type of the third sample image;
invoke the definition classification network that needs to be trained to perform classification prediction on a definition type of the third sample image, to obtain a predicted definition type of the third sample image; and
correct, based on a difference between the real definition type and the predicted definition type, a network parameter of the definition classification network that needs to be trained, to obtain the trained definition classification network.

In an embodiment, a manner in which the second obtaining module 14 obtains a first reference label of the first region and a second reference label of the second region includes:
invoking a trained image segmentation network to perform image segmentation on the first sample image, to obtain a plurality of segmented images of the first sample image, one segmented image corresponding to one definition type;
using a segmented image having a highest coincidence degree with the first region in the plurality of segmented images as a first definition matching image of the first region, and adding the first reference label for the first region based on a definition type corresponding to the first definition matching image; and
using a segmented image having a highest coincidence degree with the second region in the plurality of segmented images as a second definition matching image of the second region, and adding the second reference label for the second region based on a definition type corresponding to the second definition matching image;
the first reference definition type being a definition type corresponding to the first definition matching image, and the second reference definition type being a definition type corresponding to the second definition matching image.

According to an embodiment of this application, operations involved in the image processing method shown in FIG. 3 may be executed by the modules in the image processing apparatus 1 shown in FIG. 10. For example, operation S101 shown in FIG. 3 may be performed by the first obtaining module 11 shown in FIG. 10; operation S102 shown in FIG. 3 may be performed by the invoking module 12 shown in FIG. 10; operation S103 shown in FIG. 3 may be performed by the addition module 13 shown in FIG. 10; operation S104 shown in FIG. 3 may be performed by the second obtaining module 14 shown in FIG. 10; and operation S105 shown in FIG. 3 may be performed by the correction module 15 shown in FIG. 10.

In this application, a first sample image can be obtained. The first sample image comprises a plurality of regions subjected to division, and if definitions of the regions are different, definition types of the regions are different. In addition, an attention mechanism network can be invoked to perform attention degree recognition on the plurality of regions, to obtain a first region and a second region of the plurality of regions. The attention mechanism network comprises an attention parameter, and the attention mechanism network determines, based on the attention parameter, that an attention degree to the first region is higher than an attention degree to the second region. Further, a first predicted label can be added to the first region and a second predicted label can be added to the second region based on the respective attention degrees of the attention mechanism network to the first region and the second region. The first predicted label is used for indicating that the first region belongs to a first predicted definition type, the second predicted label is used for indicating that the second region belongs to a second predicted definition type, and a definition indicated by the first predicted definition type is higher than a definition indicated by the second predicted definition type. A first reference label of the first region and a second reference label of the second region can be obtained. The first reference label is used for indicating that the first region actually belongs to a first reference definition type, and the second reference label is used for indicating that the second region actually belongs to a second reference definition type. Therefore, the attention parameter can be corrected based on a difference between the first predicted label and the first reference label and a difference between the second predicted label and the second reference label. The attention mechanism network is configured to extract an embedding feature of a palm print image based on the corrected attention parameter. The embedding feature is used for identifying an owner of a palm print in the palm print image. It can be learned that, the apparatus provided in this embodiment can add, by using an attention degree of the attention mechanism network to the region in the first sample image, the predicted label to the region of the first sample image, and a definition of a definition type indicated by a predicted label added for a region with a higher attention degree may be higher. Further, the attention parameter may be corrected according to the difference between a real label (for example, the reference label) and the predicted label of the region. Subsequently, the attention mechanism network can adopt a higher attention degree for a region with a higher definition in the palm print image by using the corrected attention parameter, and adopt a lower attention degree for a region with a lower definition in the palm print image, so that an image feature of the region with the higher definition in the palm print image can be extracted to a greater extent, and finally a more accurate embedding feature of the palm print image is extracted. More accurate classification on the palm print image (that is, more accurate identification on an owner of the palm print in the palm print image) can be implemented by using the more accurate embedding feature of the palm print image.

According to an embodiment of this application, the modules in the image processing apparatus 1 shown in FIG. 10 may be separately or wholly combined into one unit or several units, or one (or some) of the units herein may further be divided into a plurality of functionally smaller subunits, which can implement same operations without affecting implementation of the technical effects of this embodiment of this application. The foregoing modules are divided based on logical functions. In an actual application, a function of one module may also be implemented by a plurality of units, or functions of a plurality of modules are implemented by one unit. In other embodiments of this application, the image processing apparatus 1 may also include other units. In an actual application, the functions may alternatively be cooperatively implemented by other units and may be implemented with collaboration by a plurality of units.

According to an embodiment of this application, a computer program that can perform operations in the corresponding method shown in embodiments of this application may be run on a general computer device (the computer device may include processing elements and storage elements such as a central processing unit (CPU), a random access storage medium (RAM), and a read-only storage medium (ROM)), to construct the image processing apparatus 1 shown in FIG. 10. The computer program may be recorded in, for example, a computer-readable recording medium, and may be loaded into the foregoing computer device by using the computer-readable recording medium, and run in the computer device.

Referring to FIG. 11, FIG. 11 is a schematic structural diagram of a computer device according to an embodiment of this application. As shown in FIG. 11, a computer device 1000 may include a processor 1001, a network interface 1004, and a memory 1005. In addition, in some embodiments, the computer device 1000 may further include: a user interface 1003 and at least one communication bus 1002. The communication bus 1002 is configured to implement connection and communication between these components. The user interface 1003 may include a display and a keyboard. In an embodiment, the user interface 1003 may further include a standard wired interface or wireless interface. In an embodiment, the network interface 1004 may include a standard wired interface or a standard wireless interface (such as a Wi-Fi interface). The memory 1005 may be a high-speed RAM memory, or may be a non-volatile memory, such as at least one magnetic disk memory. In an embodiment, the memory 1005 may alternatively be at least one storage apparatus that is located far away from the foregoing processor 1001. As shown in FIG. 11, the memory 1005, which is a type of computer storage medium, may include an operating system, a network communication module, a user interface module, and a device control application program.

In the computer device 1000 shown in FIG. 11, the network interface 1004 may provide a network communication function; the user interface 1003 is mainly an interface configured to provide input for a user; and the processor 1001 may be configured to invoke the device control application program stored in the memory 1005, to implement the following operations:
obtaining a first sample image, the first sample image comprising a plurality of regions subjected to division, and if definitions of the regions are different, definition types of the regions being different;
invoking an attention mechanism network to perform attention degree recognition on the plurality of regions, to obtain a first region and a second region of the plurality of regions, the attention mechanism network comprising an attention parameter, and the attention mechanism network determining, based on the attention parameter, that an attention degree to the first region is higher than an attention degree to the second region;
adding a first predicted label to the first region and adding a second predicted label to the second region based on the respective attention degrees of the attention mechanism network to the first region and the second region, the first predicted label being used for indicating that the first region belongs to a first predicted definition type, the second predicted label being used for indicating that the second region belongs to a second predicted definition type, and a definition indicated by the first predicted definition type being higher than a definition indicated by the second predicted definition type;
obtaining a first reference label of the first region and a second reference label of the second region, the first reference label being used for indicating that the first region belongs to a first reference definition type, and the second reference label being used for indicating that the second region belongs to a second reference definition type; and
correcting the attention parameter based on a difference between the first predicted label and the first reference label and a difference between the second predicted label and the second reference label, the attention mechanism network being configured to extract an embedding feature of a palm print image based on the corrected attention parameter, and the embedding feature being used for identifying an owner of a palm print in the palm print image.

The computer device 1000 described in this embodiment of this application may perform the descriptions of the foregoing image processing method in the embodiments of this application, or may perform the descriptions of the foregoing image processing apparatus 1 in the foregoing embodiment corresponding to FIG. 10. Details are not described herein again. In addition, descriptions of beneficial effects of using the same method are not described herein again.

In addition, this application further provides a computer-readable storage medium, having a computer program stored therein. When executing the computer program, a processor can perform the descriptions of the image processing method in embodiments of this application. Therefore, details are not described herein again. In addition, descriptions of beneficial effects of using the same method are not described herein again. For technical details not disclosed in the embodiment of the computer storage medium in this application, refer to the descriptions of method embodiments of this application.

In an example, the foregoing computer program may be deployed to be executed on one computer device, on a plurality of computer devices located at one place, or on a plurality of computer devices distributed at a plurality of places and interconnected through a communication network. The plurality of computer devices distributed at the plurality of places and interconnected through the communication network may form a blockchain system.

The foregoing computer-readable storage medium may be an internal storage unit of the foregoing computer device, for example, a hard disk or memory of the computer device. The computer-readable storage medium may be an external storage device of the computer device, for example, a removable hard disk drive, a smart media card (SMC), a secure digital (SD) card, or a flash card equipped on the computer device. Further, the computer-readable storage medium may alternatively include both an internal storage unit and an external storage device of the computer device. The computer-readable storage medium is configured to store the computer program and other programs and data that are required by the computer device. The computer-readable storage medium may be further configured to temporarily store data that has been outputted or is to be outputted.

This application provides a computer program product, including a computer program, the computer program being stored in a computer-readable storage medium. A processor of a computer device reads the computer program from the computer-readable storage medium, and the processor executes the computer program, to cause the computer device to perform the descriptions of the foregoing image processing method in embodiments of this application. Therefore, details are not described herein again. In addition, descriptions of beneficial effects of using the same method are not described herein again. For technical details not disclosed in the embodiment of the computer-readable storage medium in this application, refer to the descriptions of the method embodiments of this application.

In the specification, claims, and accompanying drawings of embodiments of this application, the terms “first” and “second” are intended to distinguish between different objects but do not indicate a particular order. In addition, the term “include” or any variation thereof is intended to cover a non-exclusive inclusion. For example, a process, method, apparatus, product, or device that includes a series of steps or modules is not limited to the listed steps or units; and instead, further includes an operation or module that is not listed, or further includes another operation or unit that is intrinsic to the process, method, apparatus, product, or device.

A person of ordinary skill in the art may be aware that, units and algorithm operations of the examples described in the foregoing embodiments provided in this specification may be implemented by electronic hardware, computer software, or a combination thereof. To clearly describe the interchangeability between the hardware and the software, the foregoing has generally described compositions and operations of each example based on functions. Whether the functions are executed in a mode of hardware or software depends on particular applications and design constraint conditions of the technical solutions. A person skilled in the art may use different methods to implement the described functions for each particular application, but it should not be considered that the implementation goes beyond the scope of the present application.

The foregoing disclosed embodiments are merely preferred embodiments of this application, and it is clear that, the scope of the claims of this application is not limited thereto. Therefore, any equivalent modification made according to the claims of this application shall fall within the scope of this application.

What is claimed is:

1. An image processing method performed by a computer device, the method comprising:
obtaining a first sample image, the first sample image comprising a plurality of regions;
invoking an attention mechanism network to perform attention degree recognition on the plurality of regions, to obtain a first region and a second region, wherein an attention degree to the first region is higher than an attention degree to the second region;
adding a first predicted label to the first region and a second predicted label to the second region based on the respective attention degrees of the first region and the second region, and a definition indicated by the first predicted label being higher than a definition indicated by the second predicted label;
obtaining a first reference label of the first region and a second reference label of the second region; and
updating the attention mechanism network based on a difference between the first predicted label and the first reference label and a difference between the second predicted label and the second reference label, the attention mechanism network being configured to extract an embedding feature of a palm print image for identifying an owner of a palm print in the palm print image.

2. The method according to claim 1, wherein the invoking the attention mechanism network to perform attention degree recognition on the plurality of regions, to obtain a first region and a second region comprises:
invoking the attention mechanism network to determine an attention weight of each region of the plurality of regions, an attention weight of any region being used for reflecting an attention degree of the attention mechanism network to the region; and
using a region of the plurality of regions whose attention weight is in a first weight range as the first region, and using a region of the plurality of regions whose attention weight is in a second weight range as the second region;
a weight value in the first weight range being greater than a weight value in the second weight range.

3. The method according to claim 1, wherein the attention mechanism network is comprised in a palm print classification network, the palm print classification network further comprises classification sub-network, and the method further comprises:
obtaining a second sample image, the second sample image being an image obtained by photographing a sample palm print, the second sample image having a palm print label, and the palm print label being used for indicating a real category of the sample palm print;
invoking the attention mechanism network to perform embedding on the second sample image, to generate a sample embedding feature of the second sample image;
invoking the classification sub-network to perform classification prediction on the sample palm print based on the sample embedding feature, to obtain a classification predicted result of the sample palm print; and
updating, based on a difference between the real category and the classification predicted result, the palm print classification network to obtain a trained palm print classification network.

4. The method according to claim 3, wherein there are a plurality of second sample images obtained by photographing the sample palm print from a plurality of photographing angles; and
the invoking the attention mechanism network to perform embedding on the second sample image to generate a sample embedding feature of the second sample image comprises:
invoking the attention mechanism network to separately perform embedding on each second sample image to generate an image embedding feature of the second sample image; and
fusing image embedding features of the plurality of second sample images, to generate the sample embedding feature.

5. The method according to claim 3, wherein the trained palm print classification network comprises a trained attention mechanism network and a trained classification sub-network, and the method further comprises:
obtaining a target palm print image of a target palm print;
invoking the trained attention mechanism network, to perform embedding on the palm print image, to generate a target embedding feature of the palm print image; and
invoking the trained classification sub-network to perform classification prediction on the target palm print based on the target embedding feature, to obtain a target category of the target palm print.

6. The method according to claim 1, wherein the obtaining the first reference label of the first region and the second reference label of the second region comprises:
invoking a trained definition classification network to perform classification prediction on a definition of the first region, to obtain a first reference definition type of the first region;
invoking the trained definition classification network to perform classification prediction on a definition of the second region, to obtain a second reference definition type of the second region; and
adding the first reference label for the first region based on the first reference definition type and the second reference label for the second region based on the second reference definition type.

7. The method according to claim 1, wherein the method further comprises:
obtaining a third sample image and a definition classification network that needs to be trained, the third sample image having a definition label, and the definition label indicating a real definition type of the third sample image;
invoking the definition classification network that needs to be trained to perform classification prediction on a definition type of the third sample image, to obtain a predicted definition type of the third sample image; and
updating, based on a difference between the real definition type and the predicted definition type, the definition classification network to obtain the trained definition classification network.

8. The method according to claim 1, wherein the obtaining the first reference label of the first region and the second reference label of the second region comprises:
invoking a trained image segmentation network to perform image segmentation on the first sample image, to obtain a plurality of segmented images of the first sample image, one segmented image corresponding to one definition type;
using a segmented image having a highest coincidence degree with the first region in the plurality of segmented images as a first definition matching image of the first region, and adding the first reference label for the first region based on a definition type corresponding to the first definition matching image; and
using a segmented image having a highest coincidence degree with the second region in the plurality of segmented images as a second definition matching image of the second region, and adding the second reference label for the second region based on a definition type corresponding to the second definition matching image;
the first reference definition type being a definition type corresponding to the first definition matching image, and the second reference definition type being a definition type corresponding to the second definition matching image.

9. A computer device, comprising a memory and a processor, the memory having a computer program stored therein, and the computer program, when executed by the processor, causing the computer device to perform an image processing method including:
obtaining a first sample image, the first sample image comprising a plurality of regions;
invoking an attention mechanism network to perform attention degree recognition on the plurality of regions, to obtain a first region and a second region, wherein an attention degree to the first region is higher than an attention degree to the second region;
adding a first predicted label to the first region and a second predicted label to the second region based on the respective attention degrees of the first region and the second region, and a definition indicated by the first predicted label being higher than a definition indicated by the second predicted label;
obtaining a first reference label of the first region and a second reference label of the second region; and
updating the attention mechanism network based on a difference between the first predicted label and the first reference label and a difference between the second predicted label and the second reference label, the attention mechanism network being configured to extract an embedding feature of a palm print image for identifying an owner of a palm print in the palm print image.

10. The computer device according to claim 9, wherein the invoking the attention mechanism network to perform attention degree recognition on the plurality of regions, to obtain a first region and a second region comprises:
invoking the attention mechanism network to determine an attention weight of each region of the plurality of regions, an attention weight of any region being used for reflecting an attention degree of the attention mechanism network to the region; and
using a region of the plurality of regions whose attention weight is in a first weight range as the first region, and using a region of the plurality of regions whose attention weight is in a second weight range as the second region;
a weight value in the first weight range being greater than a weight value in the second weight range.

11. The computer device according to claim 9, wherein the attention mechanism network is comprised in a palm print classification network, the palm print classification network further comprises classification sub-network, and the method further comprises:
obtaining a second sample image, the second sample image being an image obtained by photographing a sample palm print, the second sample image having a palm print label, and the palm print label being used for indicating a real category of the sample palm print;
invoking the attention mechanism network to perform embedding on the second sample image, to generate a sample embedding feature of the second sample image;
invoking the classification sub-network to perform classification prediction on the sample palm print based on the sample embedding feature, to obtain a classification predicted result of the sample palm print; and
updating, based on a difference between the real category and the classification predicted result, the palm print classification network to obtain a trained palm print classification network.

12. The computer device according to claim 11, wherein there are a plurality of second sample images obtained by photographing the sample palm print from a plurality of photographing angles; and
the invoking the attention mechanism network to perform embedding on the second sample image to generate a sample embedding feature of the second sample image comprises:
invoking the attention mechanism network to separately perform embedding on each second sample image to generate an image embedding feature of the second sample image; and
fusing image embedding features of the plurality of second sample images, to generate the sample embedding feature.

13. The computer device according to claim 11, wherein the trained palm print classification network comprises a trained attention mechanism network and a trained classification sub-network, and the method further comprises:
obtaining a target palm print image of a target palm print;
invoking the trained attention mechanism network, to perform embedding on the palm print image, to generate a target embedding feature of the palm print image; and
invoking the trained classification sub-network to perform classification prediction on the target palm print based on the target embedding feature, to obtain a target category of the target palm print.

14. The computer device according to claim 9, wherein the obtaining the first reference label of the first region and the second reference label of the second region comprises:
invoking a trained definition classification network to perform classification prediction on a definition of the first region, to obtain a first reference definition type of the first region;
invoking the trained definition classification network to perform classification prediction on a definition of the second region, to obtain a second reference definition type of the second region; and
adding the first reference label for the first region based on the first reference definition type and the second reference label for the second region based on the second reference definition type.

15. The computer device according to claim 9, wherein the method further comprises:
obtaining a third sample image and a definition classification network that needs to be trained, the third sample image having a definition label, and the definition label indicating a real definition type of the third sample image;
invoking the definition classification network that needs to be trained to perform classification prediction on a definition type of the third sample image, to obtain a predicted definition type of the third sample image; and
updating, based on a difference between the real definition type and the predicted definition type, the definition classification network to obtain the trained definition classification network.

16. The computer device according to claim 9, wherein the obtaining the first reference label of the first region and the second reference label of the second region comprises:
invoking a trained image segmentation network to perform image segmentation on the first sample image, to obtain a plurality of segmented images of the first sample image, one segmented image corresponding to one definition type;
using a segmented image having a highest coincidence degree with the first region in the plurality of segmented images as a first definition matching image of the first region, and adding the first reference label for the first region based on a definition type corresponding to the first definition matching image; and
using a segmented image having a highest coincidence degree with the second region in the plurality of segmented images as a second definition matching image of the second region, and adding the second reference label for the second region based on a definition type corresponding to the second definition matching image;
the first reference definition type being a definition type corresponding to the first definition matching image, and the second reference definition type being a definition type corresponding to the second definition matching image.

17. A non-transitory computer-readable storage medium, having a computer program stored therein, the computer program, when loaded and executed by a processor of a computer device, causing the computer device to perform an image processing method including:
obtaining a first sample image, the first sample image comprising a plurality of regions;
invoking an attention mechanism network to perform attention degree recognition on the plurality of regions, to obtain a first region and a second region, wherein an attention degree to the first region is higher than an attention degree to the second region;
adding a first predicted label to the first region and a second predicted label to the second region based on the respective attention degrees of the first region and the second region, and a definition indicated by the first predicted label being higher than a definition indicated by the second predicted label;
obtaining a first reference label of the first region and a second reference label of the second region; and
updating the attention mechanism network based on a difference between the first predicted label and the first reference label and a difference between the second predicted label and the second reference label, the attention mechanism network being configured to extract an embedding feature of a palm print image for identifying an owner of a palm print in the palm print image.

18. The non-transitory computer-readable storage medium according to claim 17, wherein the invoking the attention mechanism network to perform attention degree recognition on the plurality of regions, to obtain a first region and a second region comprises:
invoking the attention mechanism network to determine an attention weight of each region of the plurality of regions, an attention weight of any region being used for reflecting an attention degree of the attention mechanism network to the region; and
using a region of the plurality of regions whose attention weight is in a first weight range as the first region, and using a region of the plurality of regions whose attention weight is in a second weight range as the second region;
a weight value in the first weight range being greater than a weight value in the second weight range.

19. The non-transitory computer-readable storage medium according to claim 17, wherein the attention mechanism network is comprised in a palm print classification network, the palm print classification network further comprises classification sub-network, and the method further comprises:
obtaining a second sample image, the second sample image being an image obtained by photographing a sample palm print, the second sample image having a palm print label, and the palm print label being used for indicating a real category of the sample palm print;
invoking the attention mechanism network to perform embedding on the second sample image, to generate a sample embedding feature of the second sample image;
invoking the classification sub-network to perform classification prediction on the sample palm print based on the sample embedding feature, to obtain a classification predicted result of the sample palm print; and
updating, based on a difference between the real category and the classification predicted result, the palm print classification network to obtain a trained palm print classification network.

20. The non-transitory computer-readable storage medium according to claim 19, wherein there are a plurality of second sample images obtained by photographing the sample palm print from a plurality of photographing angles; and
the invoking the attention mechanism network to perform embedding on the second sample image to generate a sample embedding feature of the second sample image comprises:
invoking the attention mechanism network to separately perform embedding on each second sample image to generate an image embedding feature of the second sample image; and
fusing image embedding features of the plurality of second sample images, to generate the sample embedding feature.
